(19) United States
(12) Patent Application Publication
(10) Pub. No.: US 2018/0180327 A1
(43) Pub. Date: Jun. 28, 2018

(54) Acustic Filter Provide with Fluid Selector Device

(71) Applicant: Whirlpool S.A., Sao Paulo (BR)

(72) Inventors: Paulo Rogerio Carrara COUTO, Joinville (BR); Flavio Jorge Haddad KALLUF, Joinville (BR); Dietmar Erich Bernhard LILIE, Joinville (BR)

(21) Appl. No.: 15/128,685

(22) PCT Filed: Mar. 25, 2015
(86) PCT No.: PCT/BR2015/000039

§ 371 Date: Sep. 23, 2016

(30) Foreign Application Priority Data
Mar. 26, 2014 (BR) BR1020140072543

(51) Int. Cl. F25B 5/02; F16K 31/06; F04B 53/00; F16K 31/04; F25B 41/04

(52) U.S. Cl. CPC F25B 5/02; F16K 31/0606; F25B 41/043; F16K 31/041; F16K 31/0613; F04B 53/001

(57) ABSTRACT

The present invention relates to a fluid selector device for reciprocating compressor that, arranged within the airtight housing of the reciprocating compressor, is able to operate in cooling systems composed of at least two independent lines of equivalent functionality in order to select them through the selective and guided movement (axial or rotative) of displaceable actuator inside valve body that controls the fluid communication or the sealing between input pathways and output pathway of said valve body. It is also described an acoustic filter (of suction) especially suitable for mounting of the fluid selector device for the reciprocating compressor now disclosed.

### FIELD OF THE INVENTION

The present invention relates to a fluid selector device for alternative compressor, and more particularly, a fluid selector device of suction provided with at least two independent inputs, at least one unified output and at least one element selectively operable able to promote fluid communication between one of the separate input and unified output.

The subject invention further relates to an acoustic filter (suction filter) provided with at least one fluid selector device.

Said fluids selector device for alternative compressor, independently or linked to the acoustic filter, has the main objective of integrating an alternative compressor able to operate in cooling systems composed of at least two independent lines of equivalent functionality, i.e., cooling systems composed of at least two independent lines of suction, so as to enable the selection of one among at least two independent lines of fluid.

### BACKGROUND OF THE INVENTION

As is known to those skilled in the art, the current state of the art comprises a large topology of compressors, and in particular a large topology of compressors able to be used in cooling systems. In general, regardless topology, a compressor aims to compress a working fluid through successive changes of the internal volume of a compression chamber.

In the case of the alternative compressors, changing the volume of the compression chamber is performed by a compression piston, which is alternatively moved, in axial direction, within said compression chamber, which is usually defined by a hollow cylindrical body. In this topology, the alternative movement of the compression piston may be derived of an integrated set of a rotative motor, eccentric shaft and rod, or even, derived of, originating from a cursor of a linear motor.

In the case of rotative compressors, changing the volume of the compression chamber is performed by a compression axis which is eccentrically displaced, in radial direction, within said compression chamber, which is usually defined by a hollow circular body. In this topology, the eccentric movement of the compression shaft is derived from a rotative motor.

In the case of scroll compressors, multiple virtual cameras of compression are defined, and the volume change of these cameras is performed by orbital movements that occur between the spiral components. In this topology, the orbital movement of the displaceable spiral component is derived from an integrated set of a rotative motor and an Oldham ring (mechanism that transforms a rotative movement in orbital movement).

These three topologies of compressors are fully understood by the skilled technician in the art. Furthermore, cooling systems integrated by compressors with these three topologies are also known to the skilled technician in the art.

With regard to the functional use of these three compressors topologies, it can be seen that due to the constructive differences, such topologies can achieve similar objectives through different ways.

An example of this scenario refers to the different forms in which these topologies may be functionally implemented in dual-evaporation cooling systems.

As is known to the skilled in the art, dual-evaporation cooling systems comprise systems integrated by at least two independent evaporators, each operating at a different pressure. Therefore, it is necessary that the cooling system is provided with at least two also independent suction lines, which may have fluid communication with one or more compression units, depending on the topology of the compressor.

In the case of scroll compressors, and considering that multiple compression chambers, of different pressures (increasing gradient between the periphery and the center of the compression unit) are defined along the spiral components, it is relatively easy to implement a cooling system of dual evaporation.

As described and exemplified in documents U.S. Pat. No. 4,673,340, U.S. Pat. No. 5,722,257, U.S. Pat. No. 6,196,816, U.S. Pat. No. 5,996,364, U.S. Pat. No. 4,696,627, U.S. Pat. No. 6,364,643, US 20060140804, U.S. Pat. No. 7,418,833, there are provided dual-evaporation cooling systems, with scroll compressors, where each suction line is fluidly communicated to a specific region of the spiral components. Thus, a high-pressure suction line may be fluidly communicated with the central region (high pressure) of the spiral components, while the low pressure suction line may be fluidly communicated with the peripheral region (low pressure) of the spiral components.

In this case, it is necessary that at least one of the suction lines is airtight, or alternatively, it is necessary that a same housing have two airtight areas, each equalized with a single suction line. Moreover, it is noteworthy that in dual-evaporation cooling systems with scroll compressors is not necessary to select the flow of one among the two suction lines, that is, the cooling fluid of the two suction lines can be continuously sucked.

Although the implementation of dual-evaporation cooling systems in scroll compressors is relatively easy, it is noted that this compressor topology is mainly applied to high capacity systems. Furthermore, and as known to the skilled technician in the art, production and maintenance of scroll compressors are substantially more complex than the production and maintenance of alternative and rotative compressors.

In the case of rotative compressors, and considering that two or more compression independent areas can be set in a same compression chamber, it is also relatively easy to implement a dual-evaporation cooling system.

As described and exemplified in documents U.S. Pat. No. 2,976,698, U.S. Pat. No. 2,481,605, U.S. Pat. No. 4,622,828 and U.S. Pat. No. 2,333,899, there are provided dual-evaporation cooling systems, with rotative compressors, where each suction line is fluidly connected to a specific region of a single compression chamber. Obviously, this kind of embodiment requires the existence of an airtight isolating element between the two compression areas of the rotative compressor. Thus, a same compression shaft simultaneously compresses, and with different compression coefficients, the fluids existing in the compression independent areas in a same compression chamber.

In this case, it is necessary that the two suction lines are airtight; after all, alternative compressors do not provide equalization housing, as in scroll compressors and alternative compressors. Moreover, it is noteworthy that in dual-evaporation cooling systems with rotative compressors, as set out above, it is not necessary to select the flow of one among the two suction lines, that is, the cooling fluid of the two suction lines can be continuously sucked.

However, it is noted that said airtight isolating elements between the two compression areas of the rotative compressor are of high complexity, whether for manufacture, installation and maintenance.

Alternatively, said airtight isolating element used to isolate the two compression areas of the same compression chamber of the rotative compressor can be replaced by a fluid selector valve.

This kind of alternative embodiment is described and exemplified in document U.S. Pat. No. 6,428,284, where the rotative compressor defines only one compression area, and there is a need to select the fluid suction flow of one among the two suction lines. In this case, it is provided the use of a selector valve of two inputs and one output, wherein the output of said valve is arranged immediately before the compression chamber.

Still alternatively, dual-evaporation cooling systems can be easily implemented in twin rotative compressors (where there are two compression chambers isolated from each other, but with a single compression shaft for the entire set), each suction line being fluidly connected to one of the compression chambers. Nevertheless, a twin alternative compressor can, for all purposes, be considered as two independent rotative compressors, which is beyond the proposal to implement a dual-evaporation cooling systems in a single compressor.

In the case of alternative compressors, and considering that each compression unit defines only one compression chamber, it becomes essentially more complicated to implement a dual-evaporation cooling system.

An example of dual-evaporation cooling system using an alternative compressor is disclosed in document JP 2003083247, wherein said alternative compressor comprises a unit of doubled compression, i.e. defined by a single compression piston and two independent cylinders that, for all purposes, are equivalent to two different compression units. Thus, each suction line is fluidly connected to one of the compression cylinders. This embodiment, besides defining two suction lines, also defines two evaporation lines, which are unified before being fluidly connected to the evaporator.

In this case, besides there a need to use two compression cylinders, there is also a need to unify the exhaust output of the compression cylinders. These aspects, in addition to increase the manufacturing costs of the dual-evaporation cooling system, also make the compressor less stable, since a single compression unit is responsible for the actuation of two independent cylinders.

Another example of the dual-evaporation cooling system using an alternative compressor is described in document U.S. Pat. No. 5,531,078, wherein said alternative compressor comprises a conventional constructively defined by a single compression unit.

The cooling system especially cooperative with the compressor, in this example, provides for (further to the condenser and the expansion element) two independent suction lines with pressure differential between each other, one of these lines being the “high pressure line” and the other the “low pressure line”. There are still provided two valves, being one on/off valve and a check valve.

The on/off valve is disposed in some portion of the high pressure line, outside the compressor airtight housing. The check valve is disposed between the two suction lines, inside the compressor airtight housing. Thus, when the on I off valve is opened, the fluid in the high pressure line flows to the compressor head, still blocking, in this way, the low pressure line through the check valve because the pressure of the high pressure line is sufficient to maintain the check valve in blocking position to the low pressure line. When the on I off valve is closed, the fluid of the low pressure line changes the position of the check valve, occluding the low pressure line, which comes into fluid communication with the compressor head.

In this case, it is obviously noted that the alternative compressor operates only one of the two suction lines at a time, i.e., the compression of the fluids is not simultaneous, but rather selective. In this exemplification, it is noted that the two suction lines are airtight. At the most, it is also noted that said selector valve is disposed within the airtight housing of the alternative compressor.

Although theoretically functional, the dual-evaporation cooling system described in document U.S. Pat. No. 5,531,078 has multiple negative aspects relating to the “ghost volume”. The terminology “ghost volume” refers to the residual gas volume that “remains” in the piping disposed between the output valve and the compressor head.

When the on/off valve is switched, promoting the fluid communication interchange between the suction lines and the compressor head, the residual gas of the “previous suction” continues to be sucked by the compressor until the fluid of the “current suction” occupies, in fact, the entire volume of the piping disposed between the outlet valve and the compressor head, i.e., there is a delay between the on/off valve interchange and the suction pressure interchange inside the compression cylinder. Obviously, the severity of the “ghost volume” is directly proportional to the dimensions (diameter and length) of the piping disposed between the valve outlet and the compressor head.

This “ghost volume”, or even, this delay between the on/off valve interchange and the suction pressure interchange inside the compression cylinder may, severely, impair the efficiency of the entire cooling system.

Aiming to remedy this negative aspect, optimized solutions were developed, which are more fully described in document PCT/BR2011/000120.

The first solution described in document PCT/BR2011/000120 relates to a dual-suction alternative compressor, specifically designed for the implementation in dual-evaporation cooling systems, provided with two suction inlets on a single compression chamber. Accordingly, there are also provided two suction valves selectively actionable, which replace the need of a selective valve, thus solving the whole problem related to the “ghost volume”.

However, this first solution requires a complex functional adaptation, where the compression cylinder and the plate-valve need to be sized so as to receive two suction holes (and one of exhaust). At the most, it is necessary to use at least one suction valve of non-automatic actuation (as use to the suction valves of alternative compressors), preferably solenoid type, which must also be specially dimensioned to be attached to the plate-valve. Although functional, this first solution may be regarded as complex and difficult to construct.

The second solution described in document PCT/BR2011/000120 relates to a conventional alternative compressor (with compression cylinder proving for only one suction input and only one exhaust output) further comprising, additionally, a single fluid selector device and, in particular, a fluid selector device derived from two independent suction lines, that also operate at different pressures (which may be considered a “high pressure line” and a “low pressure line”). In this solution, at least one of the suction lines needs to be airtight.

Briefly, this second solution can be conceptually compared to the solution described in US document U.S. Pat. No. 5,531,078, the major difference of the second solution of document PCT/BR2011/000120 relates to the use of a single device responsible for the selection of one among two suction lines rather than two valves, as described in said document U.S. Pat. No. 5,531,078. As a result, said second solution of PCT/BR2011/000120 embodiment comprises a more robust, practical and efficient embodiment, because the selection of the suction fluid is performed by a single device.

However, the second solution described in document PCT/BR2011/000120 is, as can be noted, mainly conceptual, i.e., there are not described and/or exemplified possible constructive means related to fluid selector device, but only the functional principle thereof.

Thus, it is based on this scenario that the present invention arises.

### Objectives of the invention

It is therefore one objective of the subject invention to disclose optimized constructive means related to a fluid selector device for alternative compressor and, more particularly, to alternative compressors capable of operating in dual-evaporation cooling systems. Accordingly, it is another objective of the subject invention that the aforementioned fluid selector device for alternative compressors is provided with at least two independent inputs and at least one mechanism for selecting at least one among the two independent inputs.

Additionally, it is also one of the objectives of the present invention that the fluid selector device for alternative compressors now treated can be arranged in an acoustic filter belonging to the alternative compressor (inside the filter or adjacent to the filter).

### SUMMARY OF THE INVENTION

The above summarized objectives are fully achieved by the fluid selector device for alternative compressor now revealed.

According to the subject invention, said fluid selector device for alternative compressor disclosed herein is arranged within the airtight housing of the alternative compressor and comprises at least two input pathways and at least one output pathway.

Thus, the fluid selector device for alternate compressor comprises at least one valve body, at least one displaceable actuator and at least one electromagnetic field generating member, wherein the moveable actuator is disposed within the body valve.

In general, said valve body comprises a tubular body provided with at least two input pathways and at least one output pathway, said displaceable actuator comprises a tubular body provided with at least one communication channel, at least one sealing area, and at least one interaction means cooperative with the electromagnetic field generating element.

Said electromagnetic field generating element, in turn, is able to stimulate, through the cooperative interaction means, the selective and guided movement of the displaceable actuator inside the valve body, wherein the selective and guided movement (axial or rotational) of the displaceable actuator within the valve body is able to control the fluid communication or sealing between the input pathways and the output pathway of said valve body.

Thus, according to the subject invention, the functional state change of said fluid selector device for alternative compressor is triggered by at least one pulse generated by the electromagnetic field generating element, and the maintenance of the functional state of said fluid selector device for alternative compressor is triggered by the non-driving of the electromagnetic field generating element. It means that the fluid selector device for alternative compressor is preferably bistable.

In not limited way, the fluid selector device for alternative compressor disclosed herein may comprise a fluid selector device of suction.

According to the subject invention, it is also foreseen an acoustic filter provided with a fluid selector device, said filter being arranged within the airtight housing of the alternative compressor and comprises at least two distinct pathways of fluid admission and at least one pathway of fluid exhaust.

According to the subject invention, said acoustic filter provided with fluid selector device comprises at least one airtight chamber provided with at least one first admission pathway, at least one second admission pathway hermetically isolated from the airtight chamber and at least one fluid selector device comprised of at least one valve body, at least one displaceable actuator and at least one electromagnetic field generating element.

Said fluid selector device for alternative compressor now disclosed is arranged within the airtight housing of the alternative compressor and comprises at least two input pathways and at least one output pathway.

Thus, the fluid selector device for alternative compressor comprises at least one valve body, at least one displaceable actuator and at least one electromagnetic field generating element, wherein the displaceable actuator is arranged within the body valve.

In general, said valve body comprises a tubular body provided with at least two input pathways and at least one output pathway, and said displaceable actuator comprises a tubular body provided with at least one communication channel, at least one sealing area, and at least one interacting means cooperative with the electromagnetic field generating element.

Said electromagnetic field generating element, in turn, is able to stimulate, through the cooperative interacting means, the selective and guided movement of the displaceable actuator inside the valve body, wherein the selective and guided movement (axial or rotational) of the displaceable actuator within the valve body is able to control the fluid communication or sealing between the input pathways and the output pathways of said valve body.

### BRIEF DESCRIPTION OF THE DRAWINGS

The present invention will be described in detail based on the illustrative figures listed below, which:

FIG. 1 illustrates a first example of the dual-evaporation cooling system pertaining to the current state of the art;

FIG. 2 illustrates a dual-evaporation cooling system in accordance with the subject invention;

FIG. 3 illustrates, in exploded perspective, a first embodiment of the fluid selector device in accordance with the subject invention;

FIGS. 4A and 4B illustrate two constructive possibilities of the displaceable actuator belonging to the first embodiment of the fluid selector device according to the subject invention;

FIGS. 5A, 5B and 5C illustrate, in schematic section, the fluid selector device of FIG. 3 in different operational situations;

FIG. 6 illustrates a constructive possibility of the first embodiment of the fluid selector device in accordance with the subject invention;

FIG. 7 illustrates, in exploded perspective, a second embodiment of the fluid selector device in accordance with the subject invention;

FIGS. 8A, 8B and 8C illustrate, in schematic section, the fluid selector device of FIG. 7 in different operational situations;

FIG. 9 illustrates, in perspective, the upper portion of the acoustic filter provided with at least one fluid selector device according to the present invention; and

FIGS. 10A, 10B and 10B illustrate possible embodiments of the acoustic filter provided with at least one fluid selector device according to the present invention.

### DETAILED DESCRIPTION OF THE INVENTION

The objects of the present invention will be described in detail and explained with reference to the accompanying drawings, which have a merely illustrative character, not limitative, since adaptations and modifications can be made without thereby escaping from the scope of the invention claimed.

Preliminarily, and as previously mentioned, it is the main objective of the present invention to disclose optimized constructive ways referring to a fluid selector device for alternative compressor, and more particularly, for alternative compressors capable of operating in cooling systems composed of at least two independent lines of equivalent functionally (at least two suction independent lines), in order to enable the selection of one among at least two fluid independent lines.

So, references are made to the figures described above to clarify the current and general state of the art with more relevance to the present invention and to describe in detail the preferred embodiments of the present invention.

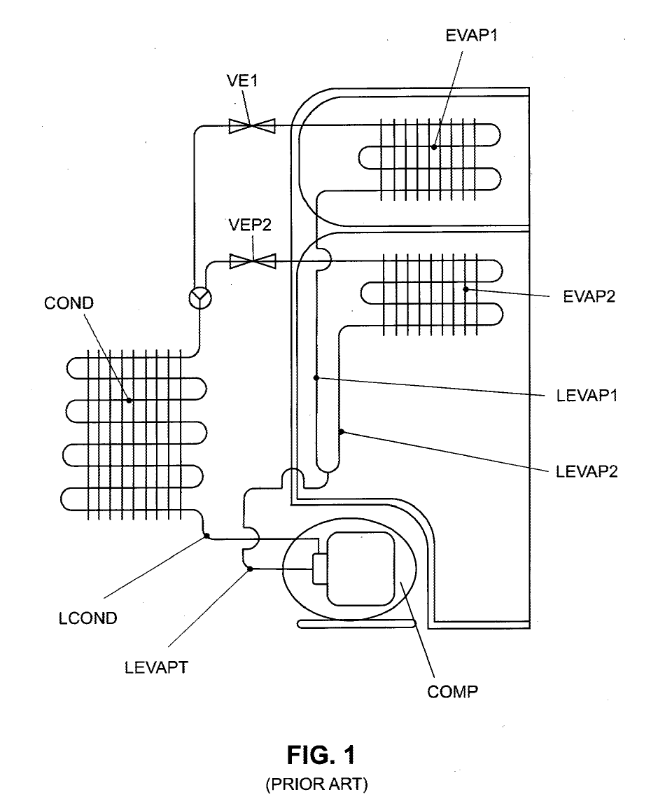

FIG. 1 schematically illustrates a dual-evaporation cooling system pertaining to the current state of the art.

Such system is mainly composed of a compressor COMP, by a condenser COND, by a check valve SV, by two expansion valves VE1 and VE2 and two evaporators EVAP1EVAP2. Condenser COND is fluidly connected to compressor COMP via a condensation line LCOND, and evaporators EVAP1 and EVAP2 are fluidly connected to compressor COMP via a single evaporation line LEVAPT, which is actually the connection between the two evaporation lines LEVAP1 and LVAP2 of evaporators EVAP1 and EVAP2. It means that compressor COMP is provided with a single discharge dowel (connected to condensation line LCOND) and a single suction dowel (connected to evaporator line LEVAPT). In this case, it is noteworthy that compressor COMP tends to work with only one of the two evaporation lines LEVAP1 and LEVAP2 at a time, and the selection between them is carried out by check valve VS located outside compressor COMP and, more particularly, just after the output of condenser COND. The problems of this type of embodiment are widely known, besides having been explained in the section “BACKGROUND OF INVENTION” of this specification. It is emphasized; however, that evaporation line LEVAPT is usually subjected to a mixture of the two derived from the two evaporation lines LEVAP1 and LVAP2 of evaporators EVAP1 and EVAP2.

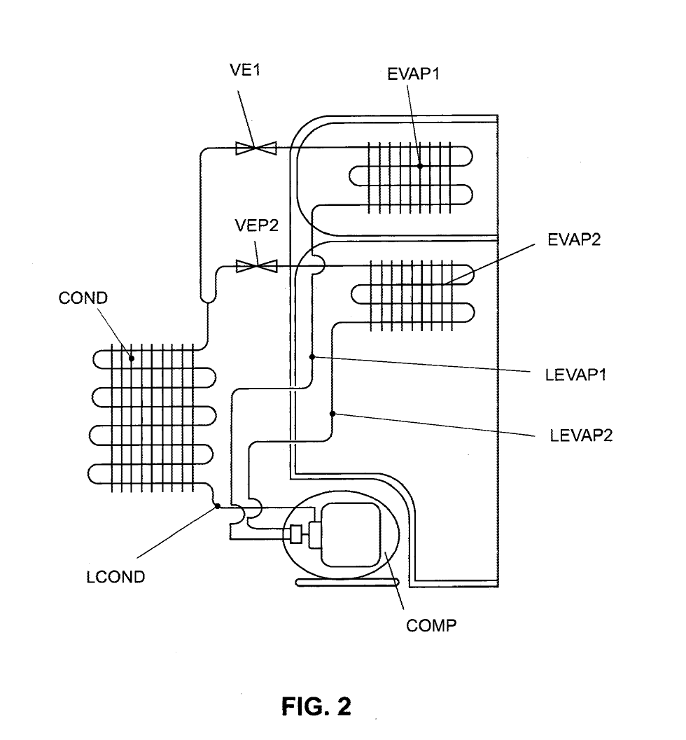

FIG. 2 shows a dual-evaporation cooling system able to operate with the fluid selector device of suction for alternative compressor now disclosed. The cooling system illustrated in FIG. 2 is essentially comprised of a compressor COMP, a condenser COND, two expansion valves VE1 and VE2 and two evaporators EVAP1 and EVAP2, the condenser COND being fluidly connected to compressor COMP via a condensation line LCOND, and evaporators EVAP1 and EVAP2 are fluidly connected to compressor COMP via two evaporation lines LEVAP1 and LEVAPT2, which are completely independent of each other, i.e. not connected to each other.

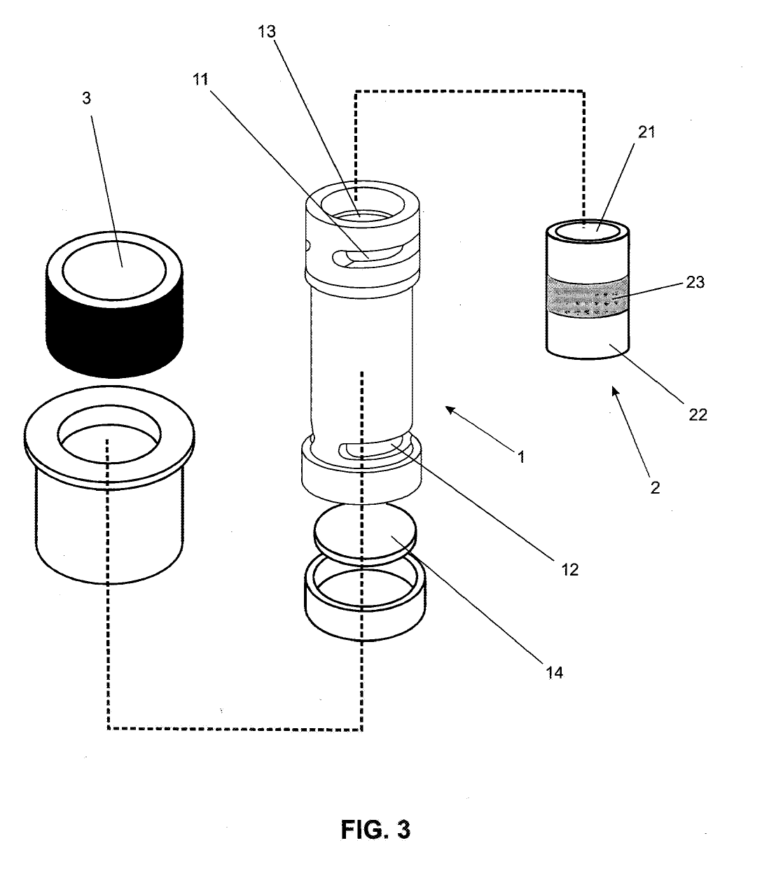

In this case, it is noteworthy that compressor COMP tends to work with only one of the two evaporation lines LEVAP1 and LEVAP2 at a time, and the selection between them is performed by said fluid selector device of suction for alternative compressor (not shown in FIG. 3), which will have the preferred embodiment thereof detailed below.

FIG. 3 illustrates the preferred embodiment of the fluid selector device for alternative compressor according to the present invention.

According to this preferred embodiment, the fluid selector device for alternative compressor basically consists of three main elements: a valve body 1, a displaceable actuator 2 and an electromagnetic field generating element 3, the displaceable actuator 2 arranged within the valve body 1.

Preferably, the valve body 1 comprises a tubular cylinder made of metal alloy. Optionally, this tubular cylinder could still be made of polymer alloy or any other rigid alloy. The valve body 1 also includes at least two windows (or holes) axially spaced from each other, defining two input pathways 11 and 12. It is evident that it might optionally be provided for multiple windows defining multiple input pathways.

Since the valve body 1 is tubular, at least one of the axial ends thereof further defines an output pathway 13. The axial end opposed to the end regarded as output pathway 13 is closed preferably with the aid of a sealing element 14, which comprises a plug of geometry similar to the geometry of valve body 1. Thus, it is important to keep in mind that valve body 1 according to the preferred embodiment of the present invention; it is a simple tubular body having a closed axial end and at least two windows defined in the wall thereof, which are axially spaced.

It is important that the valve body 1 above mentioned contains at least two input pathways 11, 12, and a single output pathway 13.

In the example of the cooling system of FIG. 2, it is observed that the input pathways 11 and 12 are capable of fluid connection, each one with one of the evaporation lines LEVAP2 and LEVAP1. This fluid communication may be performed through several conventional means, such as welding or other means equivalent and widely known to those technicians skilled in the art.

The output pathway 13 is also capable of fluid connection with the suction hole of the compression mechanism of the alternative compressor (not shown), and that fluid communication may also be performed through several conventional means, such as welding or other means equivalent and widely known by those technician skilled in the art.

In this preferred embodiment, the input pathways 11 and 12 are perpendicular to the output pathway 13. In any case, it is important to highlight that (considering only valve body 1) the input pathways 11, 12 and the output pathway 13 present, all, fluid communication with each other.

Preferably, the input pathways 11 and 12 of valve body 1 comprises axially spaced and radially aligned holes, also preferably, at least one input pathway 11 and 12 of valve body 1 comprising axially spaced, radially aligned and equidistantly arranged holes as shown in FIG. 3.

Preferably, the displaceable actuator 2 also comprises a tubular cylinder made of metal alloy. Optionally, this tubular cylinder could still be made of polymer alloy or any other rigid alloy. Free of windows or other holes, the displaceable actuator 2 has only the two axial openings thereof, thereby defining a sort of communication channel 21. That is, said communication channel 21 of the displaceable actuator 2 comprises a longitudinal channel defined within the perimeter of said displaceable actuator 2.

In addition, said displaceable actuator 2 also includes a means 23 of cooperative interaction with electromagnetic field generating element 3. Preferably, said means 23 of cooperative interaction is a magnet of fixed magnetic field preferably housed in the wall, or even, at the ends of said displaceable actuator 2. Optionally, two magnets can be used, each provided by a single opposed fixed magnetic field.

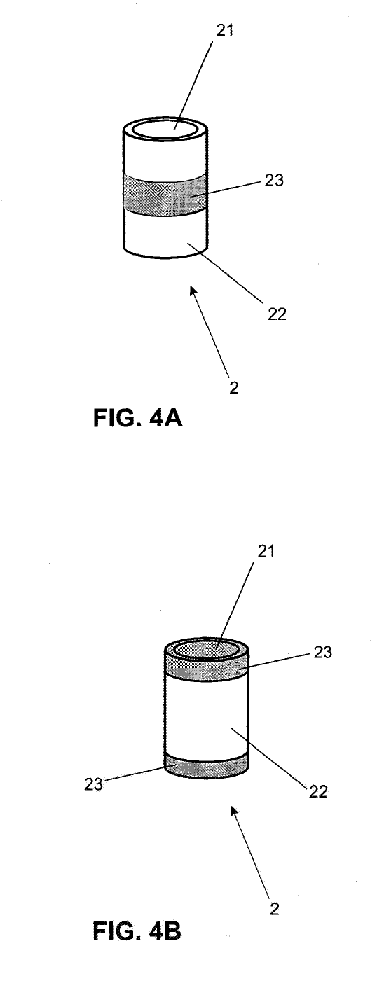

In FIG. 4A, means 23 of cooperative interaction comprises a magnet arranged in the middle portion of displaceable actuator 2. In FIG. 4B, means 23 of cooperative interaction comprises two magnets arranged, each one, in the distal portions of displaceable actuator 2.

The general idea is that the displaceable actuator 2 contains an electromagnetically component excitable upon driving of the electromagnetic field generating means 3. Thus, it is preferred that means 23 of cooperative interaction with electromagnetic field generating element 3 (preferably, a magnet of fixed magnetic field) is arranges in the own second tubular body 2.

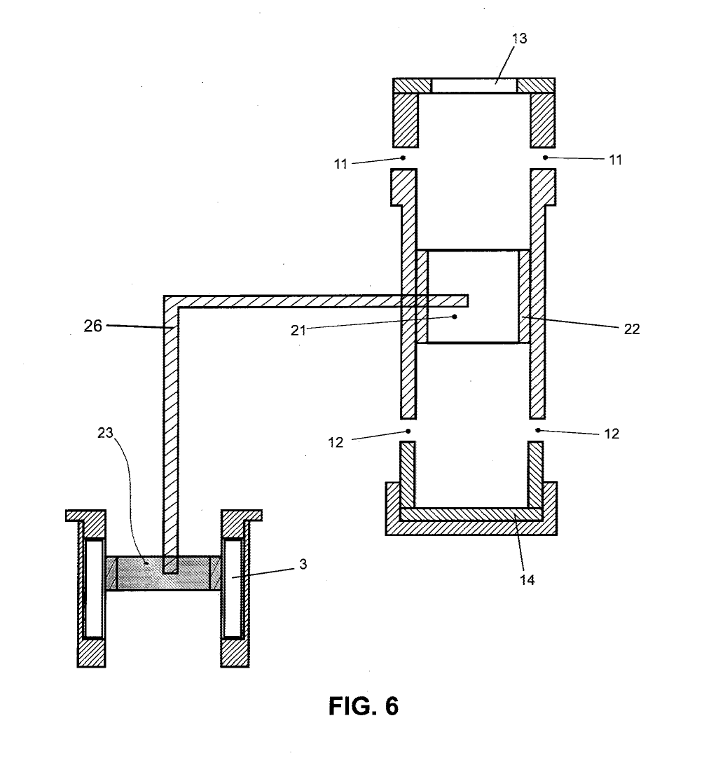

Optionally, and as illustrated in FIG. 6, there is also the possibility that means 23 of cooperative interaction of the displaceable actuator 2 comprises at least one connecting element 26 able to convert and transmit, proportionally, the magnetic variations of the electromagnetic field generating element 3 to the second tubular body 2.

In this case, it can be said that means 23 of cooperative interaction with electromagnetic field generating element 3 is remotely arranged relative to the displaceable actuator 2; however, connected in a cooperative way to the displaceable actuator 2 by means of a connecting element 26.

This optional possibility is mentioned only to make clear that means 23 of cooperative interaction with the electromagnetic field generating element 3 (one or more magnets excitable due to the driving of the electromagnetic field generating element 3) is not mandatorily arranged in the own displaceable actuator 2, and may be remote.

Preferably, the electromagnetic field generating element 3 comprises a solenoid and/or an electromagnet, i.e., any electromagnetic component that, when electrically energized, is capable of generating an attraction and/or repulsion force in ferrous metal components.

According to the present preferred embodiment, the electromagnetic field generating element 3 is arranged around the valve body 1 and, in particular, in the median portion thereof.

Said electromagnetic field generating element 3 is able to stimulate, through means 23 of cooperative interaction, the selective and guided movement of the displaceable actuator 2 within the valve body 1, i.e., said electromagnetic field generating element 3 has the main objective of generating an attraction and/or repulsion force on means 23 of cooperative interaction with the electromagnetic field generating element 3 arranged in displaceable actuator 2.

Accordingly, it is also noted that displaceable actuator 2 is arranged within valve body 1 so as to be able to present, in a selective and guided manner, axial (or linear) movement within said valve body 1. This selective and guided axial displacement is obviously imposed by the actuation of electromagnetic field generating element 3. Since second displaceable actuator 2 is arranged inside first valve body 1, it is possible to position (and keep positioned) part of displaceable actuator 2 on one of the input pathways 11 and 12 of valve body 1, so as to occlude it.

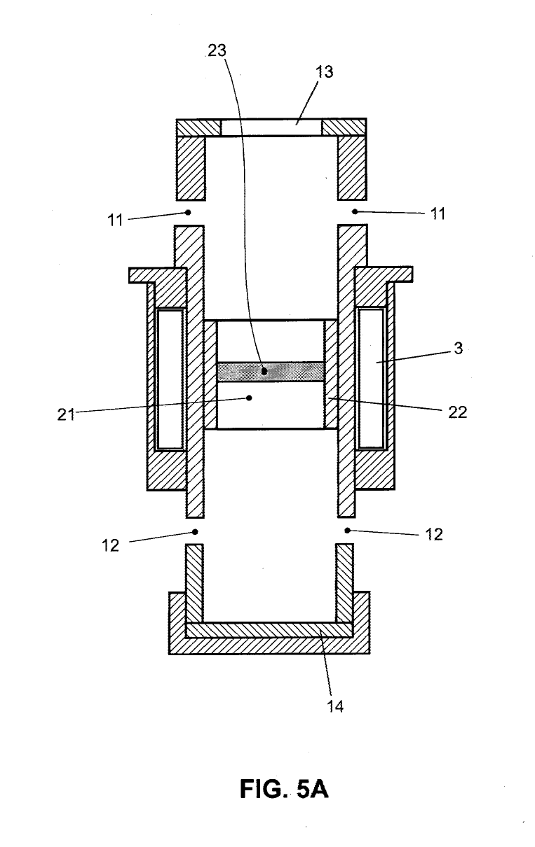

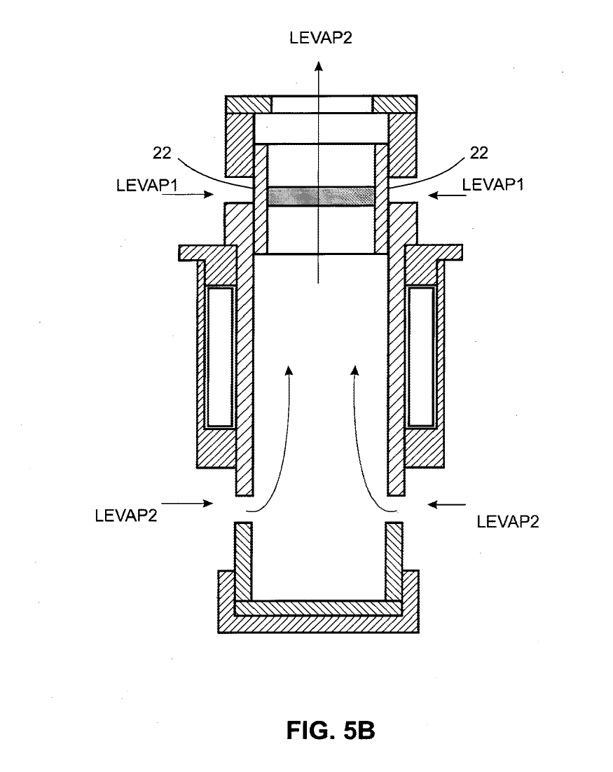

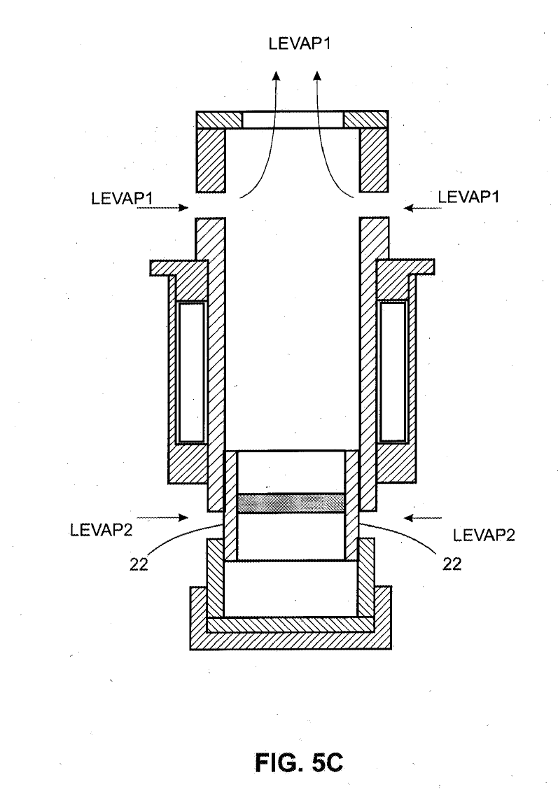

As indicated in FIGS. 5A, 5B and 5C, the displaceable actuator portion 2 which locks input pathway 11 and 12 of valve body 1 is referred to as sealing area 22.

More particularly, it is defined as sealing area 22 the displaceable actuator portion 2 whose outer diameter is the same as the inner diameter of valve body 1. In the case of the present preferred embodiment, sealing area 22 comprises the outer face of displaceable actuator 2 that plays the sealing role to input pathways 11 and 12 of valve body 1.

Thus, the fluid communication between at least one input pathway 11 and 12 and output pathway 13 of valve body 1 occurs due to alignment between said inlet pathway 11 and 12, communication channel 21of displaceable actuator 2 and said output pathway 13. On the other hand, the sealing between at least one input pathway 11 and 12 and output pathway 13 of the valve body 1 occurs due to the alignment between said input pathway 11 and 12 and sealing area 22 of displaceable actuator 2.

Thus, it can be stated that the selective and guided axial movement of displaceable actuator 2 inside valve body 1 is able to control the fluid communication or sealing between input pathways 11 and 12 and output pathway 13 of said valve body 1. That is, the change of position of displaceable actuator 2 within valve body 1 alters the functional state of said fluid selector device for alternative compressor and the maintenance of position of displaceable actuator 2 inside valve body 1 maintains the functional state of said fluid selector device for alternative compressor.

Regarding the sealing, it is necessary to emphasize that, since it comprises two tubular cylindrical bodies (valve body 1 and displaceable actuator 2), the sealing area 22, when acting, defines a radial sealing between one of the input pathways 11 and 12 and the output pathway 13, which diametrical gap is preferably a value between 5 and 30 micrometers.

This type of sealing is extremely interesting by the fact that the efficiency thereof is the same regardless the fluid pressure acting on the sealed inlet pathway, that is, because it comprises a sealing in radial direction, the high pressure in the sealed pathway is not able to cause some unintended movement in displaceable actuator 2, after all, the moving course of displaceable actuator 2 is axial while a possible high pressure in the sealed input pathway would cause only a radial stress and perpendicular to the direction of movement of displaceable actuator 2.

In addition, this type of sealing, where the inlet pressures are perpendicular to the displacement direction of displaceable actuator 2, allows the fluid selector device for alternative compressor to present a bitable operation, that is, the change of functional state of said fluid selector device for alternative compressor is triggered by at least one pulse generated by electromagnetic field generating element 3, while the maintenance of the functional state of said fluid selector device for alternative compressor is not triggered by the non-actuation of electromagnetic field generating element 3.

In other words, it is noted that the axial movement of displaceable actuator 2 within the valve body I requires only one excitation pulse generated by electromagnetic field generating element 3, not being required to maintain said electromagnetic field generating element 3 energized so that the displaceable actuator 2 keeps up static, after all, once positioned (in order to occlude an input pathway and fluidly communicate the other input pathway with the output pathway) there will be no force able to change this position (after all, the only “contrary” force acting is the force/pressure of the occluded inlet pathway, however, this force/pressure does not act in the movement direction of displaceable actuator 2, not being able to change the position thereof). This feature is important, after all, there is no energy waste regarding the actuation of electromagnetic field generating element 3.

Thus, and as illustrated in FIG. 5B, considering that said fluid selector device for alternative compressor is fluidly connected to the two evaporation lines EVAP1 and EVAP2 in FIG. 2, it is possible to select one of these two evaporation lines.

Considering, for example, that the compressor needs to suck only the coolant fluid of evaporation line EVAP2, it is only needed to actuate electromagnetic field generating element 3 so as to move (either by attraction or repulsion) means 23 of cooperative interaction with electromagnetic field generating element 3, causing the consequent displacement of displaceable actuator 2 within valve body 1 so that sealing area 22 of displaceable actuator 2 occludes the input pathway of valve body 1 that is fluidly connected to evaporation line EVAP1. Since the inlet of valve body 11that is fluidly connected to evaporation line EVAP1 is blocked and/or occluded by sealing area 22 of displaceable actuator 2, only the coolant fluid of evaporation line EVAP2, that goes through the unlocked input pathway, moves to the output pathway of valve body 1. The opposite situation, where the compressor needs to suck only the coolant fluid of evaporation line EVAP1 is illustrated in FIG. 3D, in this situation the same functional logic occurs, i.e., the displaceable actuator 2 is moved in order to occlude the input pathway of interest, to do so, it is only needed to actuate electromagnetic field generating element 3 contrary to the actuation of situation illustrated in FIG. 5C, i.e., if the position of displaceable actuator 2, in FIG. 5B, is caused by a “positive pulse”, the position of displaceable actuator 2, in FIG. 5V, will be caused by a “negative pulse”.

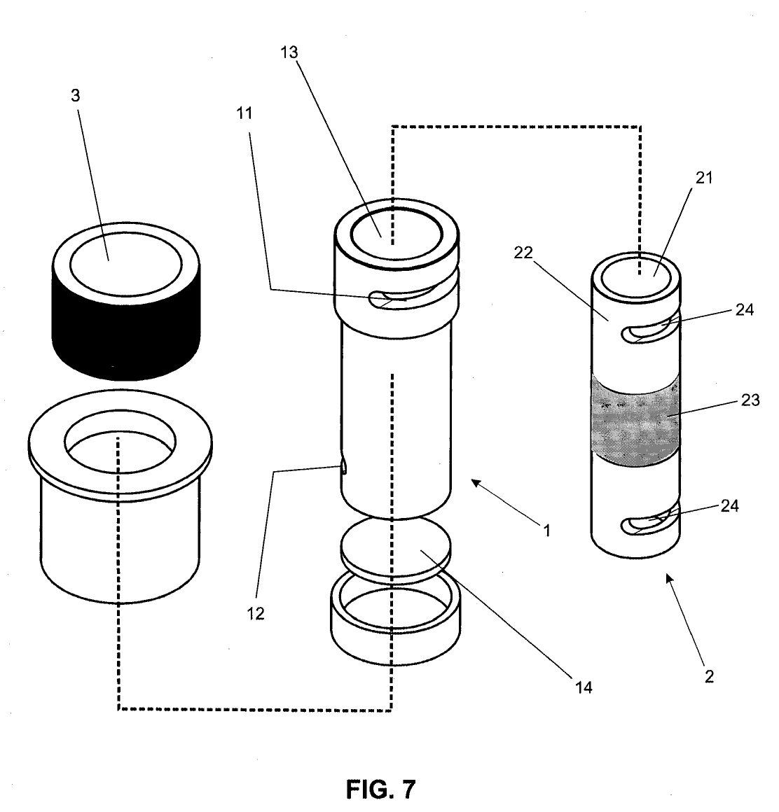

FIG. 7 illustrates an alternative embodiment of the fluid selector device for alternative compressor, according to the present invention.

According to this alternative embodiment, the fluid selector device for alternative compressor is fundamentally composed of three main elements: a valve body 1, a displaceable actuator 2 and an electromagnetic field generating element 3, the displaceable actuator 2 being arranged within valve body 1.

Preferably, valve body 1 comprises a tubular cylinder made of metal alloy. Optionally, this tubular cylinder could still be made of polymer alloy or any other rigid alloy. Valve body 1 also includes at least two windows (or holes) axially spaced from each other and, indeed, radially non-aligned, defining two input pathways 11 and 12. Since valve body 1 is tubular, at least one of the axial ends thereof further defines an output pathway 13. The axial end opposed to the end regarded as output pathway 13 is preferably closed with the aid of a sealing element 14, which comprises a plug with geometry similar to the geometry of valve body 1. Thus, it is important to keep in mind that valve body 1 according to the preferred embodiment of the subject invention, is a simple tubular body with a closed axial end and at least two windows defined in the wall thereof, which are axially spaced and radially non-aligned (or in angular manner). It is important that the aforementioned valve body 1 contains at least two input pathways 11, 12 and a single output pathway 13. In this alternative embodiment, the input pathways 11 and 12 are perpendicular to the output pathway 13. Anyway, it is important to note that (considering only valve body 1) input pathways 11 and 12 and output pathway 13 present, all, fluid communication with each other.

In the example of cooling system of FIG. 2, it is observed that input pathways 11 and 12 are capable of fluid connection, each one, with one of evaporation lines LEVAP2 and LEVAP1. This fluid communication may be performed through different conventional means, such as welding or other means equivalent and widely known to those skilled technicians in the art. The output pathway 13 is also capable of fluid connection with the suction hole of the compression mechanism of the alternative compressor (not shown), and that fluid communication may also be performed using different conventional means, such as welding or other means equivalent and widely known by the ones skilled in the subject matter.

Also according to this alternative embodiment, displaceable actuator 2 also comprises a tubular cylinder made of metal alloy. Optionally, this tubular cylinder could still be made of polymer alloy or any other rigid alloy.

Contrary to the preferred embodiment where the displaceable actuator is free from windows or other holes, displaceable actuator 2 of this alternative embodiment comprises two rips 24 axially spaced and radially aligned, also comprising only one of the free axial ends thereof, the opposite axial end being closed with the aid of a sealing element 25. However, displaceable actuator 2 of this alternative embodiment (as well as the displaceable actuator of the preferred embodiment) also defines a sort of communication channel 21, which comprises a longitudinal channel defined within the perimeter of said displaceable actuator 2.

Further, said displaceable actuator 2 also includes a means 23 of cooperative interaction with the electromagnetic field generating element 3 Preferably, said means 23 of cooperative interaction is a magnet of fixed magnetic field preferably housed in the wall, or even, at the ends of said displaceable actuator 2. Optionally, two magnets may be used, each one provided with only one opposing fixed magnetic field.

The general idea is that displaceable actuator 2 contains an electromagnetically component excitable upon actuation of electromagnetic field generating element 3. Thus, it is preferred that means 23 of cooperative interaction with electromagnetic field generating member 3 (preferably, a magnet of fixed magnetic field) is arranged in the own second tubular body 2.

Optionally, there is the possibility that means 23 of cooperative interaction of displaceable actuator 2 comprises at least one mechanical extensor able to convert and transmit, proportionally, the magnetic variations of electromagnetic field generating member 3 to second body tube 2. In this optional not illustrated embodiment, it is provided for a magnet excitable upon the actuation of electromagnetic field generating element 3 remotely arranged regarding second tubular body 2, and the physical connection between this magnet and second tubular body 2 may be performed by an extensor rod. This optional possibility is mentioned only to make clear that means 23 of cooperative interaction with electromagnetic field generating element 3 (one or more magnets excitable upon the actuation of electromagnetic field generating element 3) is not mandatorily arranged in the own displaceable actuator 2, and may be remote.

Preferably, electromagnetic field generating element 3 comprises a solenoid 3 and/or an electromagnet, i.e., any electromagnetic component that, when electrically energized, is capable of generating an attraction and/or repulsion force in ferrous metal components. According to the present alternative embodiment, electromagnetic field generating element 3 is arranged around valve body 1 and, in particular, in the median portion thereof.

Said electromagnetic field generating element 3 is able to stimulate, through means 23 of cooperative interaction, the selective and guided movement of the displaceable actuator 2 within valve body 1, i.e., said electromagnetic field generating element 3 has the main objective of generating an attraction and/or repulsion force on means 23 of cooperative interaction with electromagnetic field generating element 3 arranged in displaceable actuator 2.

Accordingly, it is also noted that displaceable actuator 2 is arranged within valve body 1 so as to be able to present, in a selective and guided manner, rotational movement inside said valve body 1. This selective and guided rotational movement is, obviously, imposed by the actuation of electromagnetic field generating element 3. Since second displaceable actuator 2 is arranged inside first valve body 1, it is possible to position (and keep positioned) part of displaceable actuator 2 on one of the two input pathways 11 and 12 of valve body 1, so as to occlude it.

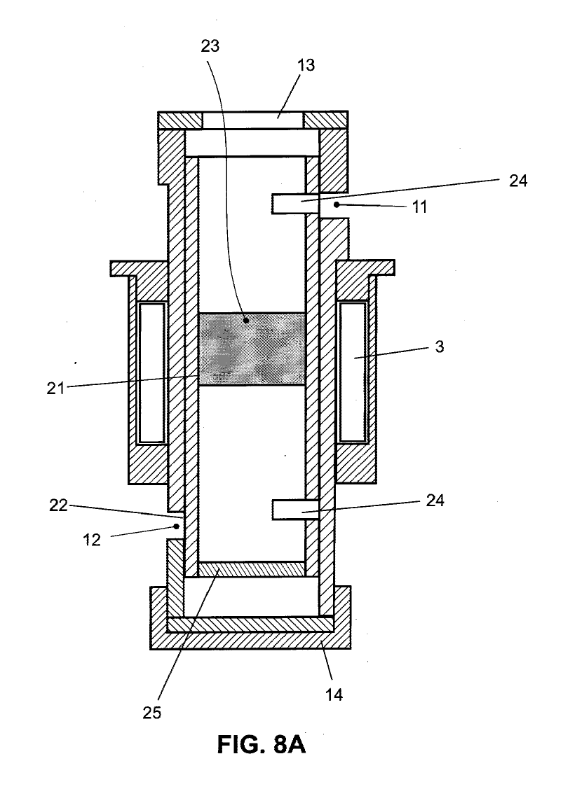

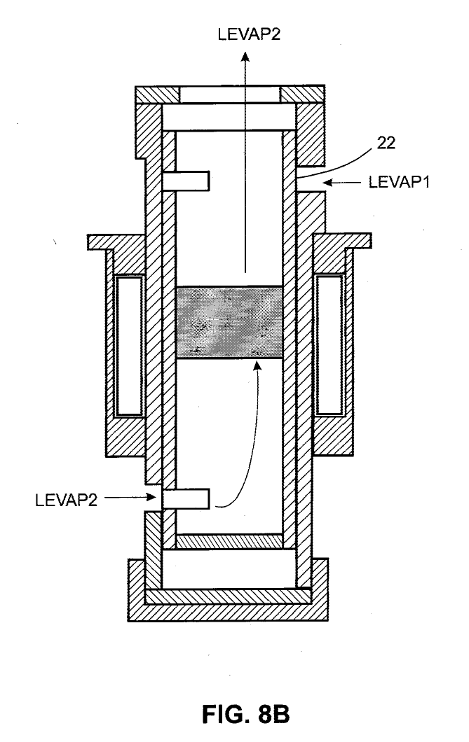

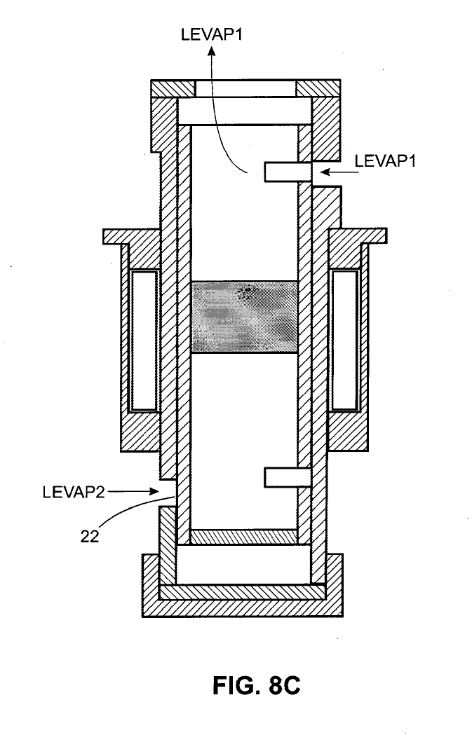

As indicated in FIGS. 8A, 8B and 8C, the portion of displaceable actuator 2 which locks the input pathway 11 and 12 of valve body 1 is referred to as sealing area 22. More particularly, it is defined as sealing area 22 the portion of displaceable actuator 2 whose outer diameter is the same as the inner diameter of valve body 1. In the case of this preferred embodiment, sealing section 22 comprises outer face of displaceable actuator 2 which play the role of sealing to input pathways 11 and 12 of valve body 1.

Thus, the fluid communication between at least one input pathway 11 and 12 and output pathway 13 of valve body 1 occurs due to the alignment between said input pathway 11 and 12, one of rips 24 of displaceable actuator 2, communication channel 21 of displaceable actuator 2 and said output pathway 13.

On the other hand, the sealing between at least one input pathway 11 and 12 and output pathway 13 of valve body 1 occurs due to the alignment between said input pathway 11 and 12 and sealing area 22 of displaceable actuator 2.

Thus, it can be stated that the selective and guided rotational movement of displaceable actuator 2 inside valve body 1 is able to control the fluid communication or sealing between the input pathways 11 and 12 and output pathway 13 of said valve body 1. That is, the change of position of displaceable actuator 2 within valve body 1 changes the functional state of said fluid selector device for alternative compressor and the maintenance of position of displaceable actuator 2 inside valve body 1 maintains the functional state of said fluid selector device of alternative compressor.

Regarding sealing, it is necessary to emphasize that, since it comprises two tubular cylindrical bodies (valve body 1 and displaceable actuator 2), sealing area 22, when acting, defines a radial sealing between one of input pathways 11 and 12 and outlet pathway 13 of valve body 1. This type of sealing is extremely interesting by the fact that the efficiency thereof is the same regardless the fluid pressure acting on the sealed input pathway, that is, it comprises a sealing in radial direction, the high pressure in the sealed input pathway is unable to cause some unintended movement in displaceable actuator 2, after all, the moving course of displaceable actuator 2 is rotational, while a possible high pressure in the sealed input pathway would cause only a non-conflicting radial effort with the movement direction of displaceable actuator 2.

In addition, this type of sealing, where the input pressures are different to the displacement direction of displaceable actuator 2,it allows that the fluid selector device to alternative compressor presents a bistable operation, that is, the change of functional state of said fluid selector device for alternative compressor is triggered by at least one pulse generated by the electromagnetic field generating element 3 while the maintenance of the functional state of said fluid selector device for alternative compressor is triggered by the non-actuation of electromagnetic field generating element 3.

In other words, it is noted that the rotational movement of displaceable actuator 2 within valve body 1 requires only one excitation pulse generated by the electromagnetic field generating element 3, not being required to maintain said electromagnetic field generating element 3 energized so that displaceable actuator 2 keeps up static, after all, once positioned (in order to occlude an input pathway and fluidly communicate the other input pathway with the output pathway) there will be no force able to change this position (after all, the only “contrary” force acting is the force/pressure of occluded input pathway, however, this force/pressure does not act in the movement direction of displaceable actuator 2, not being able to change the placement of it). This feature is important, after all, there is no energy waste regarding the actuation of electromagnetic field generating element 3.

Thus, as shown in FIG. 8B, and considering that said fluid selector device for alternative compressor is fluidly connected to the two evaporation lines EVAP1 and EVAP2 in FIG. 2, it is possible to select one of these two evaporation lines. Considering, for example, that the compressor needs to suck only the coolant fluid of evaporation line EVAP2, it is only needed to actuate electromagnetic field generating member 3 so as to move (either by attraction or repulsion) means 23 of cooperative interaction with electromagnetic field generating element 3, causing the consequent rotation of displaceable actuator 2 inside valve body 1, so that lower rip 24 of displaceable actuator 2 is aligned to the input pathway of evaporation line EVAP2 and sealing area 22 of displaceable actuator 2 occludes the input pathway of valve body 1 which is fluidly connected to evaporation line EVAP1. The opposite situation, where the compressor needs to suck only the coolant fluid of evaporation line EVAP1, is illustrated in FIG. 8C, in this situation occurs the same functional logic, i.e., displaceable actuator 2 is rotated so that upper rip 24 of displaceable actuator 2 is aligned to the input pathway of evaporation line EVAP1 and sealing area 22 of displaceable actuator 2 occludes input pathway of valve body 1 that is fluidly connected to evaporation line EVAP2, to act accordingly, it is only needed to actuate electromagnetic field generating element 3 contrary to the actuation of situation illustrated in FIG. 8B, that is, if the position of movable actuator 2, in FIG. 8B, is caused by a “positive pulse”, the positioning of movable actuator 2, in FIG. 8C, will be caused by a “negative pulse”.

According to the main objectives of the present invention, it is worth emphasizing that, regardless the preferred or alternative embodiment, fluid selector device for alternative compressor may comprise suction fluid selector device for alternative compressor.

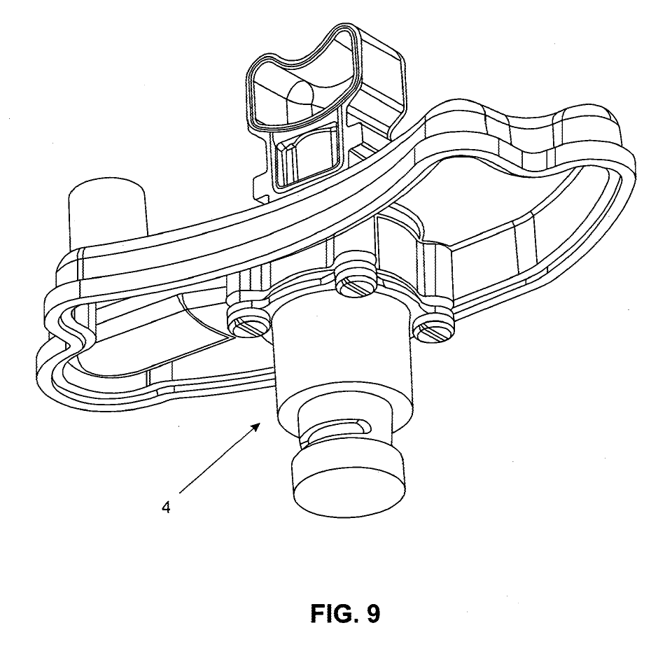

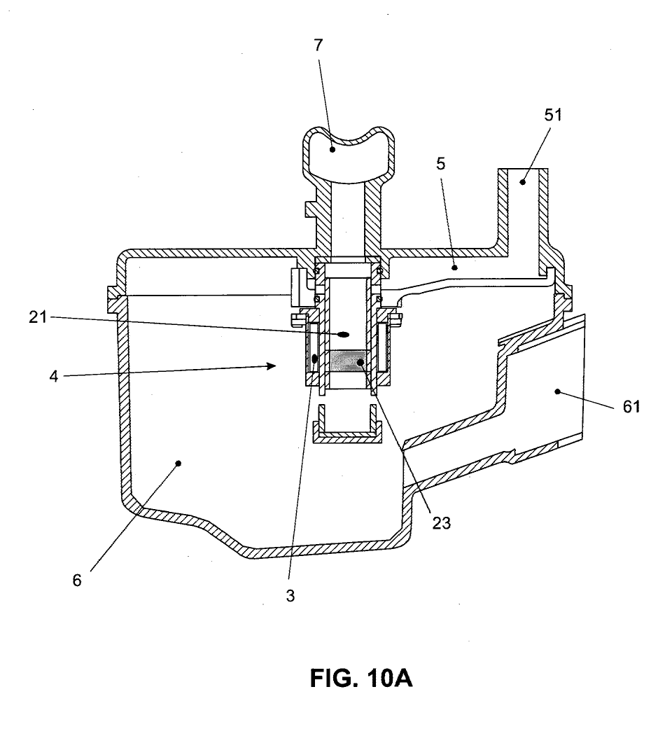

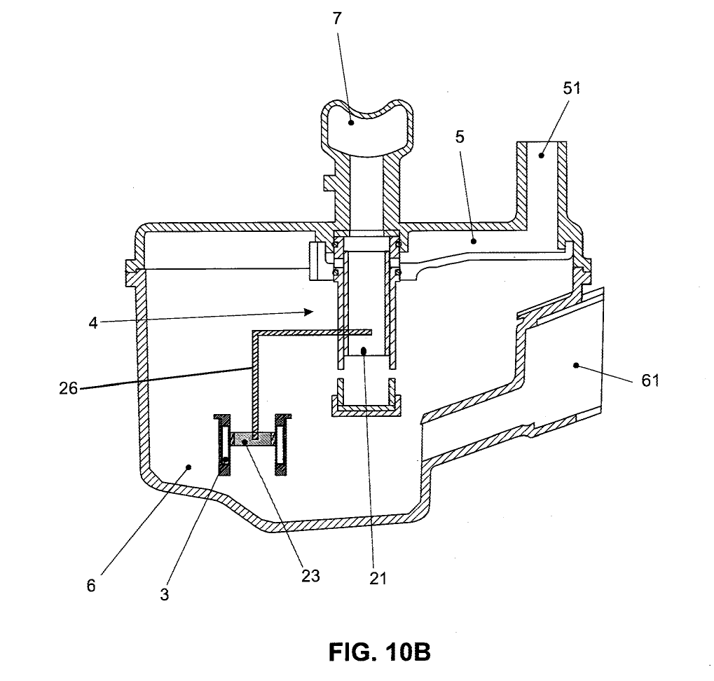

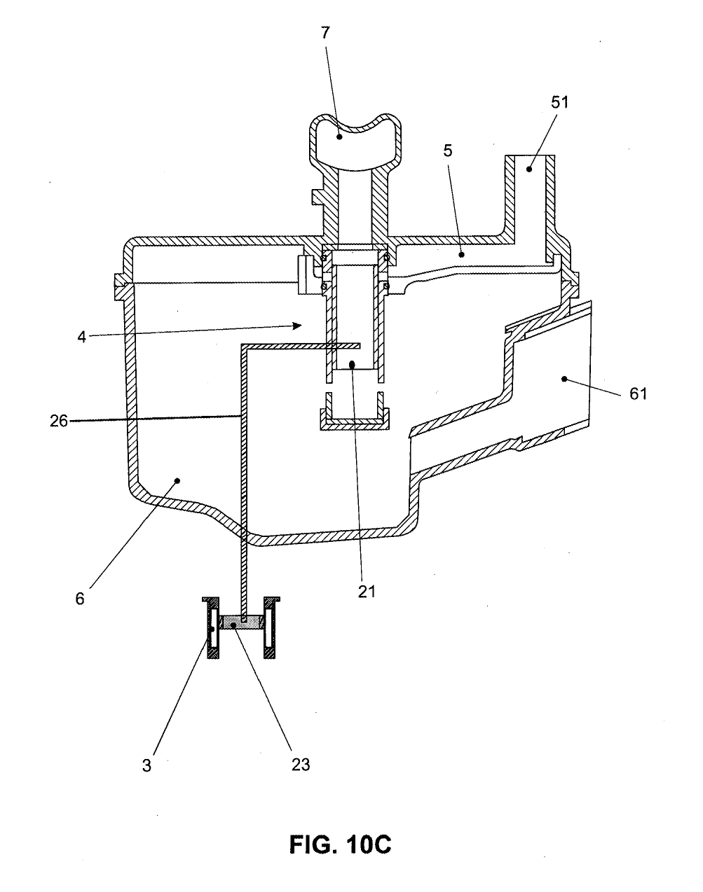

According to the present invention, it is also envisaged an acoustic filter, of suction, specially designed to receive the preferred embodiment or the alternative embodiment of the fluid selector device for alternative compressor. The integration, so to speak, the fluid selector device for alternative compressor with the acoustic filter of alternative compressor is best illustrated in FIGS. 9, 10A, 10B and 10C.

Thus, the acoustic filter provided with fluid selector device (arranged within the airtight housing of the alternative compressor) comprises at least two distinct pathways of fluid admission and at least one fluid exhaust pathway. More particularly, said acoustic filter comprises an airtight chamber 5 provided with a first admission pathway 51, a second admission pathway 61 hermetically isolated from airtight chamber 5, and a fluid selector device for alternative compressor as described above and referenced by number indication 4.

In general, hermetic chamber 5 of acoustic filter is fluidly connected to input pathway 11 of valve body 1, second admission pathway 61 of the suction acoustic filter is fluidly connected to input pathway 12 of valve body 1 and exhaust pathway 7 of the acoustic filter is fluidly connected to the output pathway 13 of valve body 1.

In particular, it is further noted that second admission pathway 61 can be associated with a second chamber 6, which can be airtight or equalized to the airtight housing of alternative compressor.

In general, the herein mentioned acoustic filter (excluding, of course, the existence of the fluid selector device for alternative compressor) can be considered an acoustic filter based on acoustic filters already existing, differing from these by having two fluid inputs and only one fluid output.

Therefore, and as mentioned above, it is necessary that the said acoustic filter contains at least one isolated chamber so that it doesn't occur an improper mixture of coolant fluids from different cooling lines.

With specific reference to FIG. 10B, it can be seen that both means 23 of cooperative interaction with electromagnetic field generating means 3, and the own electromagnetic field generating element 3 may be physically disconnected from fluid selector device 4 and arranged within the acoustic filter. With regard to FIG. 10C, it can be seen that both means 23 of cooperative interaction with electromagnetic field generating means 3, and the own electromagnetic field generating element 3 may be physically disconnected from fluid selector device 4 and arranged, inclusive, out of the acoustic filter.

Having described examples of the preferred and alternative embodiments of the objects of the subject invention, it should be understood that the scope of the present invention may include other possible variations, which are solely limited by the wording of the claims, including therein the possible equivalent means.

1. Acoustic filter provided with fluid selector device, said acoustic filter suitable to being arranged inside an airtight housing of a reciprocating compressor, said acoustic filter comprising at least two distinct fluid admission pathways and at least one fluid exhaust pathway; the acoustic filter provided with fluid selector device is characterized by the fact that it comprises:
at least one airtight chamber provided with at least one first admission pathway;
at least one second admission pathway hermetically isolated from airtight chamber; and
at least one fluid selector device comprising:
at least one valve body, at least one displaceable actuator and at least one electromagnetic field generating element;
said valve body comprises a tubular body provided with at least two input pathways and at least one output pathway;
said displaceable actuator comprises a tubular body provided with at least one communication channel, at least one sealing area,
and at least one means of cooperative interaction with electromagnetic field generating element;
displaceable actuator is arranged within valve body;
said electromagnetic field generating element is able to stimulate, through means of cooperative interaction, the selective and guided movement of displaceable actuator inside valve body;
the selective and guided movement of displaceable actuator inside valve body is able to control the fluid communication or sealing between input pathways and output pathways of said valve body.

2. Acoustic filter provided with fluid selector device, according to claim 1, characterized by the fact that second admission pathway is arranged in a second chamber.

3. Acoustic filter provided with fluid selector device, according to claim 2, characterized by the fact that second chamber is airtight.

4. Acoustic filter provided with fluid selector device, according to claim 3, characterized by the fact that second chamber is equalized to the airtight housing of the reciprocating compressor.

5. Acoustic filter provided with fluid selector device, according to claim 1, characterized by the fact that airtight chamber is fluidly connected to input pathway of valve body of the fluid selector device.

6. Acoustic filter provided with fluid selector device, according to claim 1, characterized by the fact that second admission pathway is fluidly connected to inlet pathway of the valve body of the fluid selector device.

7. Acoustic filter provided with fluid selector device, according to claim 1, characterized by the fact that second chamber is fluidly connected to input pathway of the valve body of the fluid selector device.

8. Acoustic filter provided with fluid selector device, according to claim 1, characterized by the fact that output pathway of the valve body of the fluid selector device is fluidly connected to exhaust pathway of said acoustic filter.

9. Acoustic filter provided with fluid selector device, according to claim 1, characterized by the fact that it comprises a suction acoustic filter.
